(19) United States
(12) Patent Application Publication
(10) Pub. No.: US 2009/0084033 A1
(43) Pub. Date: Apr. 2, 2009

(54) Portable planting frame

(76) Inventors: June Duncan, Gladstone, MO (US); Lucinda Crozier, Kansas City, MO (US)

Correspondence Address: Jim Montgomery, 8th Floor, 5201 Blue Lagoon Drive, Miami, FL, 33126, US

(21) Appl. No.: 11/986,175

(22) Filed: Nov. 19, 2007

Related U.S. Application Data
(60) Provisional application No. 60/976,470, filed on Oct. 1, 2007.

(51) Int. Cl. A01G 17/04

(52) U.S. Cl. 47/45

(57) ABSTRACT

An apparatus for a portable planting frame is presented. The apparatus includes a plurality of vertical corner pieces that when arranged define positions on a perimeter of the planting frame and a plurality of horizontal connecting pieces for joining the corner pieces to form the planting frame. Means for joining the connecting pieces and the corner pieces forms the planting frame where the planting frame can be filled with planting material, the planting frame can be disassembled from around the planting material without moving the planting material and the planting frame can be reassembled.

### CROSS-REFERENCE TO RELATED APPLICATIONS

The present Utility patent application claims priority benefit of the U.S. provisional application for patent Ser. No. 60976470 filed on Oct. 1, 2007 under 35 U.S.C. 119(e). The contents of this related provisional application is incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to gardening tools. More particularly, the invention relates to a portable planting frame.

### BACKGROUND OF THE INVENTION

When planting plants in a yard, garden or other location, gardeners often use planters or planting frames for various reasons such as, but not limited to, separating plants from one another, highlighting specific plants, decoration, etc. Currently available planters are typically bulky, heavy and have closed bottoms. There are many cases when a gardener wishes to move a previously placed planter to a different location. However, the size and weight of these planters make them difficult to move and the closed bottoms prevent the contents from escaping, making the planters even heavier. Also, currently available planting frames are typically built into the garden, making them difficult if not impossible to relocate.

In view of the foregoing, there is a need for improved techniques for providing planting frames that may be moved from one location to another easily.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a front perspective view of an exemplary portable planting frame, in accordance with an embodiment of the present invention;

FIG. 2 is a front perspective view of exemplary corner posts, in accordance with an embodiment of the present invention;

FIG. 3 is an end view of an exemplary corner post, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, portable planting frame is presented.

In one embodiment, an apparatus for a portable planting flame is presented. The apparatus includes a plurality of vertical corner pieces that when arranged define positions on a perimeter of the planting flame and a plurality of horizontal connecting pieces for joining the corner pieces to form the planting frame. Means for joining the connecting pieces and the corner pieces forms the planting frame where the planting frame can be filled with planting material, the planting frame can be disassembled from around the planting material without moving the planting material and the planting frame can be reassembled. Another embodiment further includes a second plurality of vertical corner pieces and a second plurality of horizontal connecting pieces such that a depth of the planting frame can be increased by stacking the second corner and connecting pieces and means for joining the vertical corner pieces and the second vertical corner pieces where the planting frame can be disassembled from around the planting material without moving the planting material and the planting flame can be reassembled. Other embodiments include the corner pieces includes legs to provide stability when the corner pieces are stacked, the corner pieces includes fittings for use with the joining means. In other embodiments the fittings are positioned at ninety degrees to form a rectangular planting frame and the fittings are positioned at less than ninety degrees to form a triangular planting frame. In further embodiments the connecting pieces are curved to form a rounded planting flame, the corner pieces are arranged such that the planting frame is configured for use as a barrier and the corner and connecting pieces are circular in shape. In yet another embodiment, the corner and connecting pieces are constructed of plastic type materials that are lightweight for easy portability, deter insects and rodents, and generally ensure years of use without maintenance.

In another embodiment an apparatus for a portable planting frame is presented. The apparatus includes means for defining vertical positions on a perimeter of the planting frame, means for horizontally connecting the vertical positions means and means for joining the vertical positions means and the horizontally connecting means to form the planting flame where the planting flame can be filled with planting material, the planting frame can be disassembled from around the planting material without moving the planting material and the planting flame can be reassembled. Yet another embodiment further includes means for providing a second vertical positions means and horizontally connecting means such that a depth of the planting frame can be increased by stacking the second vertical positions means and horizontally connecting means and means for joining the vertical positions means and the second vertical positions means where the planting frame can be disassembled from around the planting material without moving the planting material and the planting frame can be reassembled.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Embodiments of the present invention provide lightweight portable planting frames that are easy to reposition, remove or relocate. The preferred embodiment is a collapsible frame comprising corner posts and connecting pieces.

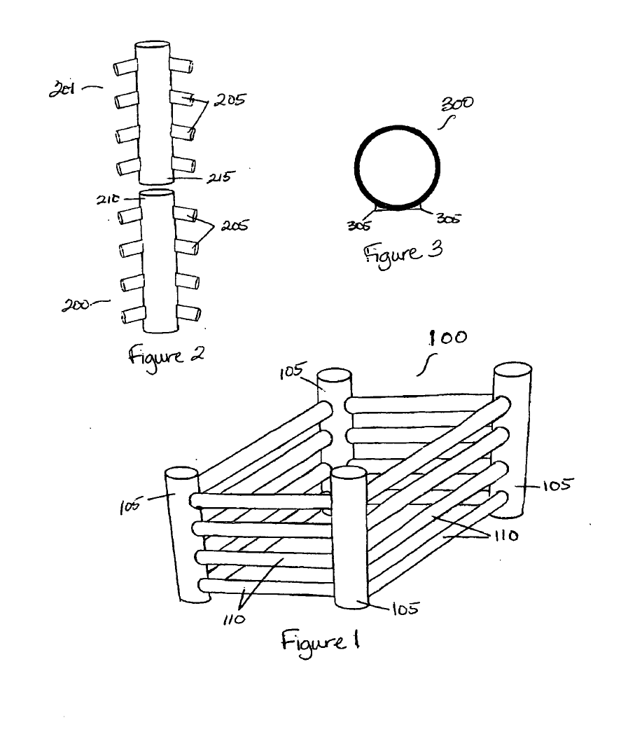

FIG. 1 is a front perspective view of an exemplary portable planting frame 100, in accordance with an embodiment of the present invention. In the preset embodiment, planting frame 100 is a lightweight portable planting device that is easy to move or reposition. Planting frame 100 is a collapsible rectangular or square frame with four corner posts 105 extending the height of planting frame 100 and multiple connector pieces 110. In the present embodiment corner posts 105 are cylindrical tubes measuring approximately three to five inches in diameter; however, in alternate embodiments, corner posts may be larger or smaller in diameter and may be differently shaped. For example, without limitation, in alternate embodiments, corner posts may be square tubes, otherwise shaped tubes, solid shapes, etc. Furthermore, corner posts 105 are able to stack on top of each other enabling one planting frame to stack over another to create a taller frame. In the present embodiment, connecting pieces 110 are cylindrical tubes; however, in alternate embodiments the connecting pieces may have various different shapes such as, but not limited to, square tubes, planks, etc.

In the present embodiment, planting frame 100 comprises sixteen collapsible connecting pieces 110 and four corner posts 105. Additional corner posts may be available in varying heights, for example, without limitation, heights of three, five or six inches tall or one, two or three feet tall, and additional connecting pieces may be available in varying lengths. Planting frame 100 can be fully customized to meet any gardener's size specifications. Furthermore, additional or fewer corner posts may be used to create shapes other than squares and rectangles such as, but not limited to, triangles, octagons, irregular shapes, etc., and additional or fewer connecting pieces may be used depending on the desired height and number of sides of the planting frame. The components of planting frame 100 can be made of various materials such as, but not limited to, fiberglass, plastic, Plexiglas™, or PVC in a wide assortment of colors. These exemplary materials are lightweight for easy portability, deter insects and rodents, and generally ensure years of use without maintenance. Some embodiments may be made of less lightweight materials for aesthetic purposes such as, but not limited to, wood or various metals.

FIG. 2 is a front perspective view of exemplary corner posts 200 and 201, in accordance with an embodiment of the present invention. Connecting pieces, such as, but not limited to, connecting pieces 105 shown by way of example in FIG. 1, slide over fittings 205 to connect corner posts 200 and 201 to other corner posts. In an alternate embodiment, the corner posts comprise slots or holes into which connecting pieces are inserted rather than fittings. In the present embodiment corner posts 200 each have eight fittings 205 in two columns of four. The columns of fittings 205 are positioned in a ninety-degree angle to create square or rectangular planting frames. In alternate embodiments the corner posts may have additional or fewer fittings, depending on various factors such as, but not limited to, the size of the connecting pieces, the use of the particular planting frame, etc. Furthermore, the fittings in some embodiments may be positioned at angles other than ninety degrees depending on the shape of the planting frame. For example, without limitation, the corner posts of a triangular planting frame may comprise corner posts with fittings at sixty-degrees.

In the present embodiment, corner posts 200 and 201 are able to stack on top of one another to create a taller corner post. In the preferred embodiment, corner posts include legs to enable stacking, as shown by way of example in FIG. 3. However, stacking may be accomplished using various alternate means. For example, without limitation, in some embodiments a top portion 210 of corner post 200 may taper so that top portion 210 fits into a bottom portion 215 of corner post 201, and in other embodiments, bottom portion 215 of corner post 201 may taper to fit into top portion 210 of corner post 200. In yet other embodiments a connector may hold corner posts 200 and 201 together. For example, without limitation, in some embodiments this connector may be a cylinder that fits into top portion 210 of corner post 200 and bottom portion 215 of corner post 201, holding corner post 201 on top of corner post 200. In other embodiments, the connector may be a collar that slides over corner posts 200 and 201 at the connection point to hold the corner posts together.

FIG. 3 is an end view of an exemplary corner post 300, in accordance with an embodiment of the present invention. In the preset embodiment, corner post 300 comprises legs 305 that enable stacking of planting frames. When corner post 300 is stacked on top of another corner post with legs, legs 305 on corner post 300 line up with and sit atop the legs on the bottom corner post. The legs provide a more stable surface for stacking than is provided by corner posts without legs.

In typical use of the preferred embodiment, a user connects corner posts together with connecting pieces creating a plating flame, for example, without limitation, planting frame 100 in FIG. 1. The user may stack another planting frame onto the first planting frame to create a taller planting frame. Once the planting frame is the desired shape and size, the user can fill the planting frame with material for planting such as, but not limited to, dirt, sand or gravel. If at any time the user wishes to move the planting frame, the user can simply reposition the portable planting frame to any area easily by taking the pieces of the planting frame apart and reassembling them in a new location. Since the preferred embodiment is bottomless, the planting frame may be disassembled from around the planting material without moving any of the heavy planting material.

Alternate embodiments of the present invention may be configured in a line to be used as a fence, retaining wall or other barrier rather than an enclosed frame. These embodiments comprise end posts with only one row of fittings and interior posts with two rows of fittings on opposing sides to create a straight line. Those skilled in the art, in light of the present teachings, will recognize that various different types of posts may be configured in different positions to create numerous different shapes of planting frames and barriers. For example, without limitation, corner posts, straight interior posts and end posts may be combined to create a barrier that zigzags around objects. In some embodiments interior posts in a barrier may have fittings at various angles enabling the barrier to bend in angles other than right angles.

Having fully described at least one embodiment of the present invention, other equivalent or alternative methods of providing a portable planting flame according to the present invention will be apparent to those skilled in the art. The invention has been described above by way of illustration, and the specific embodiments disclosed are not intended to limit the invention to the particular forms disclosed. For example, the particular implementation of the shape of the planting flame may vary depending upon the particular type of connecting pieces used. The embodiments described in the foregoing were directed to implementations with straight connecting pieces; however, similar techniques are to use curved connecting pieces to create rounded shapes such as, but not limited to, circles, semi-circles, ovals, etc. Curved implementations of the present invention are contemplated as within the scope of the present invention. The invention is thus to cover all modifications, equivalents, and alternatives falling within the spirit and scope of the following claims.

What is claimed is:

1. An apparatus for a portable planting frame, the apparatus comprising:
a plurality of vertical corner pieces that when arranged define positions on a perimeter of the planting frame;
a plurality of horizontal connecting pieces for joining said corner pieces to form the planting frame; and
means for joining said connecting pieces and said corner pieces to form the planting frame where the planting frame can be filled with planting material, the planting frame can be disassembled from around said planting material without moving said planting material and the planting frame can be reassembled.

2. The apparatus as recited in claim 1, further comprising:
a second plurality of vertical corner pieces and a second plurality of horizontal connecting pieces such that a depth of the planting frame can be increased by stacking said second corner and connecting pieces; and
means for joining said vertical corner pieces and said second vertical corner pieces where the planting frame can be disassembled from around said planting material without moving said planting material and the planting frame can be reassembled.

3. The apparatus as recited in claim 2, wherein said corner pieces comprises legs to provide stability when said corner pieces are stacked.

4. The apparatus as recited in claim 1, wherein said corner pieces comprises fittings for use with said joining means.

5. The apparatus as recited in claim 4, wherein said fittings are positioned at ninety degrees to form a rectangular planting frame.

6. The apparatus as recited in claim 4, wherein said fittings are positioned at less than ninety degrees to form a triangular planting frame.

7. The apparatus as recited in claim 1, wherein said connecting pieces are curved to form a rounded planting frame.

8. The apparatus as recited in claim 1, wherein said corner pieces are arranged such that the planting frame is configured for use as a barrier.

9. The apparatus as recited in claim 1, wherein said corner and connecting pieces are circular in shape.

10. The apparatus as recited in claim 1, wherein said corner and connecting pieces are constructed of plastic type materials that are lightweight for easy portability, deter insects and rodents, and generally ensure years of use without maintenance.

11. An apparatus for a portable planting frame, the apparatus comprising:
means for defining vertical positions on a perimeter of the planting frame;
means for horizontally connecting said vertical positions means; and
means for joining said vertical positions means and said horizontally connecting means to form the planting frame where the planting frame can be filled with planting material, the planting frame can be disassembled from around said planting material without moving said planting material and the planting frame can be reassembled.

12. The apparatus as recited in claim 11, further comprising:
means for providing a second vertical positions means and horizontally connecting means such that a depth of the planting frame can be increased by stacking said second vertical positions means and horizontally connecting means; and
means for joining said vertical positions means and said second vertical positions means where the planting frame can be disassembled from around said planting material without moving said planting material and the planting frame can be reassembled.
